(19) United States
(12) Patent Application Publication
(10) Pub. No.: US 2006/0030273 A1
(43) Pub. Date: Feb. 9, 2006

(54) Cellular phone sending inexpensive long distance voice messaging

(76) Inventor: Jasim Saleh Al-Azzawi, Arlington, VA (US)

Correspondence Address: Jasim Saleh Al-Azzawi, 1300 Army Navy Drive, Apartment 404, Arlington, VA, 22202, US

(21) Appl. No.: 10/913,436

(22) Filed: Aug. 9, 2004

(51) Int. Cl. H04B 1/00; H04B 7/00

(52) U.S. Cl. 455/72

(57) ABSTRACT

The basic principle of this invention is to add a suitable audio compression software to cellular and home phone sets to adjust the sound quality and reduce sound memory, thus for instance, a person may speak for ten minutes into the microphone of a cellular or home phone and his/her speech will be compressed to a 350 KB file to be saved on the phone memory, then by calling a cellular or home number possessing the same feature the file will be transmitted within seconds and received by the recipient even if the phone is switched off, as the duration of transmission is very short, the monetary cost of sending a file will be extremely low, the cost of sending a ten minutes voice message will drop to 1% of its actual cost as well as adding an answering machine feature to these sets.

### BACKGROUND OF THE INVENTION

This invention is in the field of cellular telephony where a new feature will be added to cellular phones to drastically reduce the cost of international and long distance voice messaging. The current cost of international and domestic long distance calls, using cellular phones, remain prohibitively expensive and outside the reach of millions of people worldwide forcing them to reduce the duration and frequency of their calls to the absolute minimum.

Thus, this invention will empower individuals to send, for example, a fifteen minutes voice message for the cost of less than half a minute phone call. The addition of this new feature to cellular phones will give people an inexpensive tool to send and receive long distance voice messages for a fraction of a regular long distance phone call.

### BRIEF SUMMARY OF THE INVENTION

This invention is designed to drastically cut the cost of sending long distance voice messaging by adding an audio compression software to cellular phones in order to adjust the sound quality and to use less memory space of the transmitted voice message. Therefore, to achieve the purpose of this invention and reduce the size of the voice message file on cellular phones an audio compression software such as “Lernout & Hauspie CELP 4.8 kbit/s” or “ACELP.net Audio sample rate 8 kHz” or “GSM 6.10 lkb/sec” . . . etc or any other appropriate and powerful audio compression software will be added to cellular phones

When an audio compression software is added to a cellular phone, a 10-15 minutes recorded voice message will be compressed to a very small file and saved on the phone memory. After sending the compressed file to another cellular phone the compressed file can either be deleted or given an identifying name and saved on the memory of the cellular phone.

An audio compression software will reduce a 5 minutes voice message to 172 KB and 10 minutes recorded voice message to 350 KB, therefore if the memory bank of the cellular phone, designated to save compressed voice messages, is 10 MB this memory will be capable of saving more than fifty compressed voice messages each five minutes long whether sent or received.

### BRIEF DESCRIPTION OF THE SEVERAL VIEWS OF THE DRAWINGS

There are no drawings.

### DETAILED DESCRIPTION OF THE INVENTION

This invention is designed to drastically cut the cost of long distance phone calls by adding an audio compression capability, such as a software, to cellular phones in order to adjust the sound quality to use less memory space of the transmitted voice message. Therefore, to achieve the purpose of the invention and reduce the size of the voice message file saved on cellular phones, an audio compression software such as “Lernout & Hauspie CELP 4.8 kbit/s” or “ACELP.net Audio sample rate 8 kHz” or “GSM 6.10 lkb/sec” . . . etc or any other appropriate and powerful audio compression software will be added to the cellular phone. When an audio compression program is added to a cellular phone, a 10-15 minutes recorded voice message will be compressed to a very small digital file and saved on the phone memory. After sending it to another cellular phone the compressed file can either be deleted or given an identifying name and saved in the phone memory. Recorded voice messages may also be saved and named to be sent later on to a cellular phone, even if the recipient's cellular phone is switched off An audio compression software will reduce a 5 minutes recorded voice message to 172 KB, and 10 minutes recorded voice message to 350 KB and 15 minutes recorded voice message to 550 KB. Therefore, if the memory bank of the cellular phone designated for the compressed voice messages is 10 MB it will be sufficient to save more than fifty compressed voice messages sent or received each five minutes long.

The time required to send a compressed voice message is approximately 10-15 seconds, costing very little regardless of the country in which transmission is initiated. Therefore, to avoid the high cost of long distance and international phone calls, a great segment of people in many parts of the world, especially in dense population centers like China, India and Indonesia as well as in some poor pockets of the rich industrialized western countries, will benefit immensely from this added feature.

When an individual receives a compressed voice message first he will listen to it and then he'll record his answer, as compressed voice message, and send it in a flash, thus, bypassing the enormous cost of a live phone call.

Businesses too can benefit from such a feature where executives and employees may send each other recorded instructions and detailed information, especially when different time zones are involved. Another added benefit is the convenience of sending and receiving long, detailed voice messages to an individual with out the need to talk to him directly, thus avoiding awkward social and business situations.

A cellular phone possessing such a feature will have a Compressed Voice Messaging option to be selected from the soft key and by selecting it and pressing the Record button a person may speak into the microphone of the cellular phone to record his message as a compressed file. Upon completion of recording the Stop button is pressed. Next, a message appears on the cellular phone screen asking to insert the recipient's cellular number to be included and complete the transmission. A recipient having a cellular phone with a similar feature may receive a compressed voice message, even if it is switched off. If it is switched on, a distinctive, optional beep is sounded to indicate the receipt of a compressed file. The beeping sound may be deactivated. When the cellular phone is switched off the received voice file is stored in the phone memory without producing a beeping signal. After listening to it a voice file may be deleted, saved, or forwarded to a third party.

A useful and highly practical option may be added to enhance this invention where a person may pre-record and save multiple messages to fit a variety of situations indicating, for example, unavailability, being asleep, engaged or traveling abroad. Thus, a pre-recorded message can be activated to serve as an automatic response to an incoming voice message or a phone call. So, upon the arrival of a voice file this particularly selected compressed voice message will be sent automatically to inform the sender of the particular circumstances of the recipient. And since these pre-recorded voice messages, explaining different circumstances are short, being approximately thirty seconds in duration, so upon their compression they will be reduced to extremely small files to be transmitted in 3-4 seconds.

This automatic reply feature is optional and may be activated or deactivated as desired at anytime. Thus, as explained in the paragraph above, this new added feature will transform cellular phones into automatic answering machines capable when receiving a voice message it will automatically respond to the caller or a voice message and provide them the appropriate desired response.

Furthermore, we may add another creative option to enhance this invention where it is possible to send automatically and continuously voice messages of predetermined duration to a single or multiple cellular phones.

Initially, through this option, an individual will select a single or multiple phone numbers. Then he'll select the desired duration of the compressed voice message, for instance, five minutes. Next, he will select start, prompting the cellular phone to start recording an ongoing family conversation or a party. After each five minutes interval the cellular phone will make an independent voice file and send it automatically to the pre-selected recipient, and it keeps sending voice file after voice file as long as this option is on. Thus, the recipient can hear a two hours conversation, with a time lag of five minutes, at a cost equivalent to three minutes direct phone call.

This invention will also enable cellular phones to send a single or multiple voice files to a single or multiple recipients, either simultaneously or in staggered sequence. Furthermore, this feature when it is made available by Internet Service Providers (ISP) to their customers will enable internet users to send compressed voice messages to cellular phones for a nominal fee.

This invention may also be added to home phone sets enabling them to record, receive and send compressed voice messages exactly like cellular phones. Once again, this invention will add an answering machine feature to home phone sets. Due to the obvious clarity of this invention it is absolutely clear that there is only one mode for carrying out this invention.

The industrial applicability of this invention will be great since current long distance and international phone calls remain beyond the financial reach of the majority of people in most Third World countries, especially extremely poor ones in Africa, India and China. According to UN reports millions of people are deprived of access to phone services and millions more have never made a single phone call in their lives due to lack of telecommunication infrastructure and low income. This invention will play a major role in giving such deprive and isolated people and communities, as well as a sizable percentage of indigent people in the industrialized countries, the capability for better communication at a negligible cost. People worldwide may communicate regionally and globally for a fraction of the cost i.e. for example a 10 minutes international voice message will be sent for the cost of sending 3-5 seconds SMS. The greatest potential and customer market for this invention lies in most of the major urban population centers of the world as well as in the greater concentration of agricultural and poor urban areas of Africa, Latin America and central Asia and many indigent pockets of Western industrialized countries.

The dual beneficial results of adding this feature to cellular phones and home phone sets will be first to empower low income people worldwide for better communication and second boost the market share and profit of manufacturers by giving them an edge over their competitors who opt not to integrate such a feature into their phones.

1. I claim a cellular phone capable of compressing a voice message, save it as a file, and send it to a recipient, this cellular phone can also receive a compressed voice message and save it on its memory for future listening purposes.

2. I claim a home phone set capable of compressing a voice message, save it as a file and send it to a recipient, this home phone set can also receive a compressed voice message and save it on its memory for future listening purposes.

3. I claim a cellular phone, as claimed in claim 1, where it is also capable of sending automatically a compressed voice message as a response to the sender, thus functioning as an automatic answering machine.

4. I claim a cellular phone as claimed in claim 1, where it is also capable of automatically and repetitively sending compressed voice messages, one file after the other, to a pre-selected phone number every few minutes for a long period of time, so that a recipient may hear hours of a conversation at a fraction of the cost of live phone call.

5. I claim a home phone set as claimed in claim 2, where it is also capable of sending automatically a compressed voice message as a response to the sender, thus functioning as an automatic answering machine.

6. I claim a home phone set as claimed in claim 2, where it is also capable of automatically and repetitively sending compressed voice messages, one file after the other, to a pre-selected phone number every few minutes for a long period of time, so that a recipient may hear hours of a conversation at a fraction of the cost of live phone call.
